(19) United States
(12) Patent Application Publication
(10) Pub. No.: US 2008/0112340 A1
(43) Pub. Date: May 15, 2008

(54) WIRELESS COMMUNICATION NETWORK AND METHOD OF DYNAMIC CHANNEL SELECTION OF A WIRELESS COMMUNICATION NETWORK

(76) Inventor: Charles J. Luebke, Sussex, WI (US)

Correspondence Address: Martin J. Moran;Eaton Electrical, Inc., Technology & Quality Center, 170 Industry Drive, RIDC Park West, Pittsburgh, PA, 15275-1032, US

(21) Appl. No.: 11/558,049

(22) Filed: Nov. 9, 2006

(51) Int. Cl. H04B 7/00

(52) U.S. Cl. 370/310

(57) ABSTRACT

A method of dynamic channel selection for a wireless communication network employs a first wireless communication channel of a first wireless radio of each of a network coordinator and a number of network devices for wireless communication therebetween. A number of different second wireless communication channels are monitored with a second wireless radio of the network coordinator. One of the different second wireless communication channels is selected as a function of background noise level or message traffic. The first wireless communication channel is monitored with the first wireless radio of the network coordinator. The first wireless communication channel is determined to have unsatisfactory quality and an identification of the selected one of the different second wireless communication channels is responsively broadcast to the network devices. The selected one of the different second wireless communication channels is employed for wireless communication between the network coordinator and the network devices.

### BACKGROUND OF THE INVENTION

1. Field of the Invention

This invention relates generally to communication networks and, more particularly, to wireless communication networks employing a network coordinator, such as a base station, and network devices, such as input sensors and/or output devices. The invention also relates to methods for wireless communication in a wireless communication network and, more particularly, to methods for channel selection.

2. Background Information

Wireless communication networks are an emerging new technology, which allows users to access information and services electronically, regardless of their geographic position.

All nodes in ad-hoc wireless communication networks are potentially mobile and can be connected dynamically in an arbitrary manner. All nodes of these networks behave as routers and take part in discovery and maintenance of routes to other nodes in the network. For example, ad-hoc wireless communication networks are very useful in emergency search-and-rescue operations, meetings or conventions in which persons wish to quickly share information, and in data acquisition operations in inhospitable terrains.

An ad-hoc mobile wireless communication network comprises a plurality of mobile hosts, each of which is able to communicate with its neighboring mobile hosts, which are a single hop away. In such a network, each mobile host acts as a router forwarding packets of information from one mobile host to another. These mobile hosts communicate with each other over a wireless media, typically without any infra-structured (or wired) network component support.

In contrast to wired networks, mesh-type, low rate-wireless personal area network (LR-WPAN) wireless communication networks are intended to be relatively low power, to be self-configuring, and to not require any communication infrastructure (e.g., wires) other than power sources.

During radio frequency communication between a network coordinator and one or more network devices, communications may be hindered or interrupted by one or more sources of background noise at various frequencies. One known method of dealing with such background noise is for the network coordinator to configure its radio to leave the present wireless channel (i.e., a first radio frequency band), to scan other wireless channels (i.e., other radio frequency bands) with that same radio, and to return to the present wireless channel and use the radio to notify the network devices to migrate to a new wireless channel (i.e., one of the other radio frequency bands).

There exists the need to intelligently and relatively more quickly locate and migrate to a new wireless channel as contrasted with the network coordinator configuring its radio to leave the present wireless channel, scanning other wireless channels with that same radio, and returning to the present wireless channel and using the radio to notify network devices to migrate to the new wireless channel.

Accordingly, there is room for improvement in wireless communication networks.

There is also room for improvement in methods of channel selection for a wireless communication network.

### SUMMARY OF THE INVENTION

These needs and others are met by embodiments of the invention, which provide a network coordinator comprising a first wireless radio employed to transmit and receive on a presently selected channel, and a second wireless radio. The network coordinator and a number of network devices wirelessly communicate by employing a first wireless communication channel as the presently selected channel. The network coordinator monitors a number of different second wireless communication channels with the second wireless radio, selects one of the different second wireless communication channels as a function of background noise level or message traffic, monitors the first wireless communication channel with the first wireless radio, and determines that the first wireless communication channel has unsatisfactory quality and responsively broadcasts an identification of the selected one of the different second wireless communication channels to the number of network devices. The network coordinator and the number of network devices wirelessly communicate between the network coordinator and the number of network devices by employing the selected one of the different second wireless communication channels as the presently selected channel.

In accordance with one aspect of the invention, a wireless communication network comprises: a network coordinator comprising a processor, a first wireless radio employed to transmit and receive on a presently selected channel, and a second wireless radio; and a number of network devices, each of the network devices comprising a processor and a wireless radio, wherein the network coordinator and the number of network devices are structured to wirelessly communicate by employing a first wireless communication channel as the presently selected channel, wherein the network coordinator is structured to monitor a number of different second wireless communication channels with the second wireless radio of the network coordinator, wherein the network coordinator is structured to select one of the different second wireless communication channels as a function of background noise level or message traffic, wherein the network coordinator is structured to monitor the first wireless communication channel with the first wireless radio of the network coordinator, wherein the network coordinator is structured to determine that the first wireless communication channel has unsatisfactory quality and responsively broadcast an identification of the selected one of the different second wireless communication channels to the number of network devices, and wherein the network coordinator and the number of network devices are structured to wirelessly communicate between the network coordinator and the number of network devices by employing the selected one of the different second wireless communication channels as the presently selected channel.

As another aspect of the invention, a method of dynamic channel selection for a wireless communication network comprises: wirelessly communicating between a network coordinator and a number of network devices by employing a first wireless communication channel of a first wireless radio of each of the network coordinator and the number of network devices; employing a second wireless radio of the network coordinator; monitoring a number of different second wireless communication channels with the second wireless radio of the network coordinator; selecting one of the different second wireless communication channels as a function of background noise level or message traffic; monitoring the first wireless communication channel with the first wireless radio of the network coordinator; determining that the first wireless communication channel has unsatisfactory quality and responsively broadcasting an identification of the selected one of the different second wireless communication channels to the number of network devices; and wirelessly communicating between the network coordinator and the number of network devices by employing the selected one of the different second wireless communication channels.

The method may further comprise determining that the first wireless communication channel has unsatisfactory quality by determining that the percentage of successful transmissions from the network coordinator to the number of network devices is less than a predetermined amount.

The method may employ as the function of background noise level or message traffic a function of lowest average background noise level.

The method may further comprise employing as the function of background noise level or message traffic the selection of one of the different second wireless communication channels that has the lowest rolling average receive signal strength indicator value.

The method may determine whether more than one of the different second wireless communication channels has the lowest rolling average receive signal strength indicator value; and select the one of the different second wireless communication channels having the lowest peak receive signal strength indicator value over a predetermined time period.

### BRIEF DESCRIPTION OF THE DRAWINGS

A full understanding of the invention can be gained from the following description of the preferred embodiments when read in conjunction with the accompanying drawings in which:

FIG. 1A is a block diagram of a wireless communication network including a network coordinator having a first radio and a second, low cost radio, and a network device having a first radio in accordance with an embodiment of the invention.

FIG. 1B is a block diagram of a network coordinator having a first radio, a second, low cost radio, and a duplexer in accordance with another embodiment of the invention.

FIG. 2 is a flowchart of a Future Channel Assessment (and Selection) Algorithm in accordance with another embodiment of the invention.

FIG. 3 is a flowchart of a Present Channel Assessment (and decision to change) Algorithm in accordance with another embodiment of the invention.

FIG. 4 is a flowchart of a Channel Migration Algorithm (Base) in accordance with another embodiment of the invention.

FIG. 5 is a flowchart of a Channel Migration Algorithm (Device) in accordance with another embodiment of the invention.

FIG. 6 a flowchart of a transmit routine employed by the network coordinator of FIG. 1B in accordance with another embodiment of the invention.

### DESCRIPTION OF THE PREFERRED EMBODIMENTS

As employed herein, the term “number” shall mean one or an integer greater than one (i.e., a plurality).

As employed herein, the term “wireless” shall expressly include, but not be limited by, radio frequency (RF), infrared, IrDA, wireless area networks, IEEE 802.11 (e.g., 802.11a; 802.11b; 802.11g), IEEE 802.15 (e.g., 802.15.1; 802.15.3, 802.15.4), other wireless communication standards (e.g., without limitation, ZigBee™ Alliance standard), DECT, PWT, pager, PCS, Wi-Fi, Bluetooth™, and cellular.

As employed herein, the term “communication network” shall expressly include, but not be limited by, any local area network (LAN), wide area network (WAN), intranet, extranet, global communication network, the Internet, and/or wireless communication system.

As employed herein, the term “network coordinator” (NC) shall expressly include, but not be limited by, any communicating device (e.g., without limitation, base station; server), which operates as the coordinator for devices wanting to join a wireless communication network and/or as a central controller in a wireless communication network.

As employed herein, the term “network device” (ND) shall expressly include, but not be limited by, any communicating device (e.g., without limitation, a portable wireless communicating device; a fob; a camera/sensor device; a wireless camera; a control device; and/or a fixed wireless communicating device, such as, for example, switch sensors, motion sensors or temperature sensors as employed in a wirelessly enabled sensor network), which participates in a wireless communication network, and which is not a network coordinator.

As employed herein, the term “node” includes NDs and NCs.

As employed herein, the term “system” shall expressly include, but not be limited by, a system for a home or other type of residence or other type of structure, or a system for a land vehicle, a marine vehicle, an air vehicle or another motor vehicle.

As employed herein, the term “system for a structure” shall expressly include, but not be limited by, a system for a home or other type of residence or other type of structure.

As employed herein, the term “system for a vehicle” shall expressly include, but not be limited by, a system for a land vehicle, a marine vehicle, an air vehicle or another motor vehicle.

As employed herein, the term “residence” shall expressly include, but not be limited by, a home, apartment, dwelling, office and/or place where a person or persons reside(s) and/or work(s).

As employed herein, the term “structure” shall expressly include, but not be limited by, a home, apartment, dwelling, garage, office building, commercial building, industrial building, a roofed and/or walled structure built for permanent or temporary use, a structure for a land vehicle, a structure for a marine vehicle, a structure for an air vehicle, or a structure for another motor vehicle.

As employed herein, the term “land vehicle” shall expressly include, but not be limited by, any land-based vehicles having pneumatic tires, any rail-based vehicles, any maglev vehicles, automobiles, cars, trucks, station wagons, sport-utility vehicles (SUVs), recreational vehicles, all-terrain vehicles, vans, buses, motorcycles, mopeds, campers, trailers, or bicycles.

As employed herein, the term “marine vehicle” shall expressly include, but not be limited by, any water-based vehicles, ships, boats, other vessels for travel on water, submarines, or other vessels for travel under water.

As employed herein, the term “air vehicle” shall expressly include, but not be limited by, any air-based vehicles, airplanes, jets, aircraft, airships, balloons, blimps, or dirigibles.

As employed herein, the terms “home wellness system” or “wellness system” or “awareness system” shall expressly include, but not be limited by, a system for monitoring and/or configuring and/or controlling aspects of a home or other type of residence or other type of structure.

The present invention is described in association with a wireless home wellness or awareness system, although the invention is applicable to a wide range of wireless communication networks, including wireless nodes, for monitoring and/or configuring and/or controlling aspects of a structure. Examples of such systems are disclosed in U.S. Patent Application Publication Nos. 2005/0085248 and 2006/0197660, which are incorporated by reference herein.

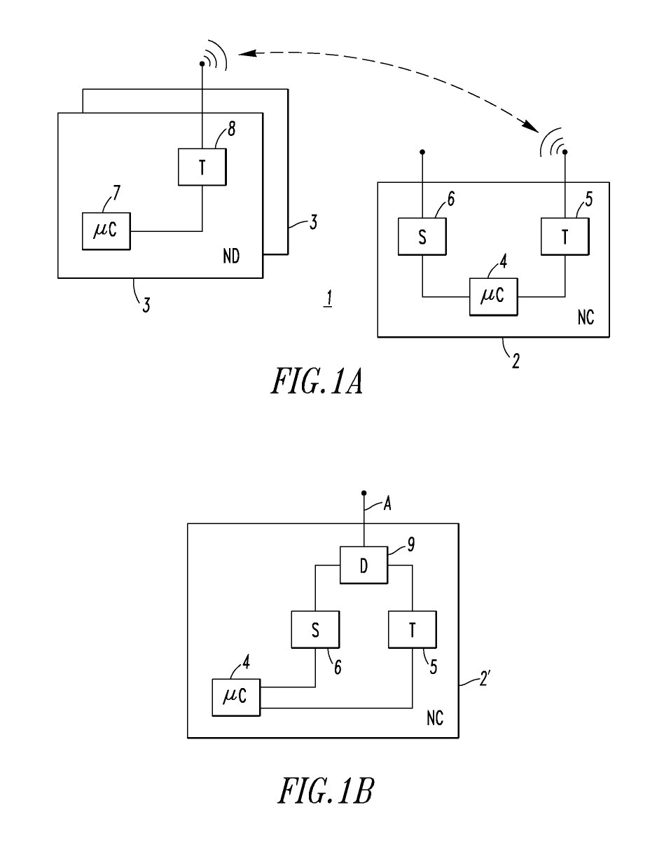

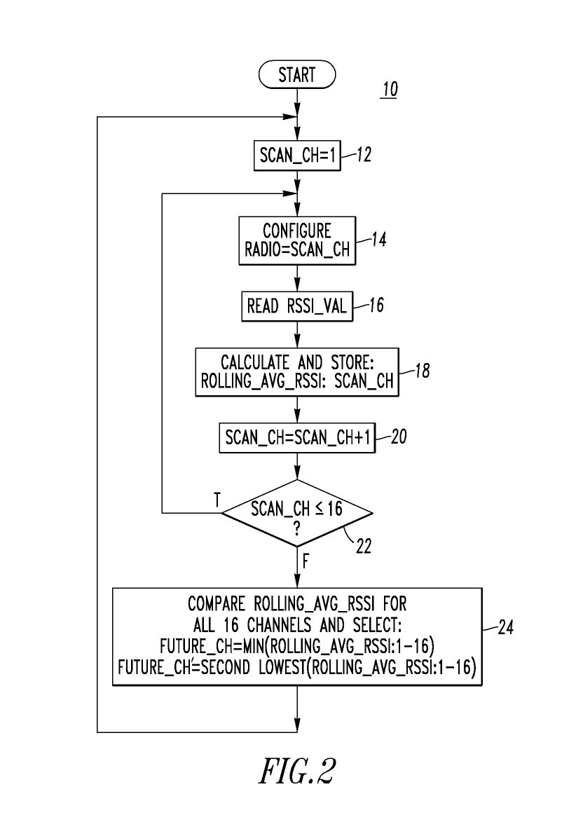

Referring to FIG. 1A, a wireless communication system 1 includes a network coordinator (NC) (e.g., base station) 2 and one or more network devices (NDs) (only one ND 3 is shown in detail). The NC 2 includes a suitable processor (e.g., μC 4), a first wireless radio T 5 and a second, low cost wireless radio S 6. The ND 3 includes a suitable processor (e.g., μC 7) and a wireless radio T 8. As will be explained, the second radio S 6 is embedded in the NC 2 and potentially other devices (not shown) to monitor other radio channels that could potentially be used if the present radio channel (used by the first radios T 5,8 (e.g., including a transmitter and a receiver)) is determined to have relatively unsatisfactory radio frequency channel quality, as will be explained. This provides a way to intelligently and more quickly locate and migrate to a new channel as contrasted with the NC 2 leaving the present channel on radio T 5, scanning other channels with radio T 5, and returning to the present channel on radio T 5 to notify NDs, such as ND 3, to migrate to the new channel.

### EXAMPLE 1

The second radio S 6 (e.g., including only a receiver) of FIG. 1A or 1B is in receive only mode, and could potentially use the same antenna A as the first radio T 5 through the use of a simple duplexer D 9 of network coordinator 2′, as shown in FIG. 1B.

### EXAMPLE 2

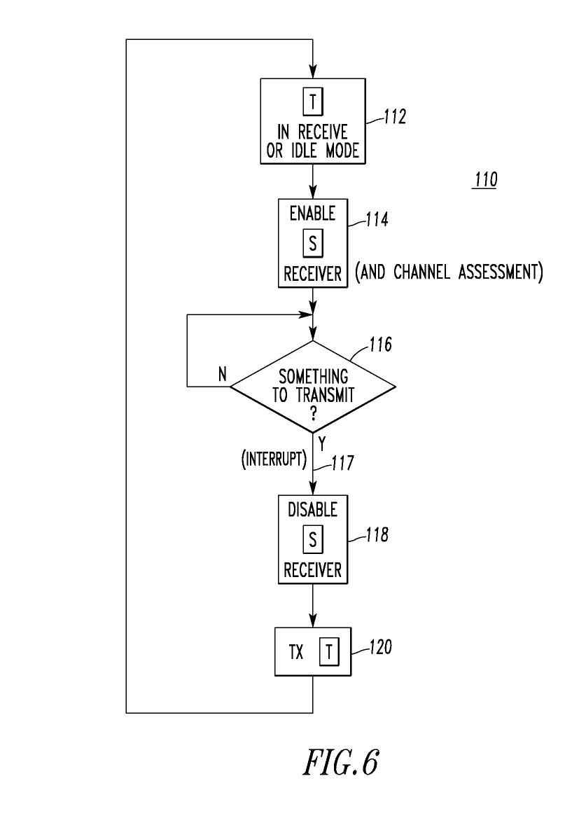

If a power amplifier (PA) (not shown) is used to transmit, then the radio receivers of the radios 5,6 must be disabled (e.g., switched out) during transmission to prevent excess power from damaging the circuitry. For example, the example radio T 5 employs a single channel for transmit and receive (half duplex); hence, “listen-while-talking” is not supported. It may also be necessary to disable the receiver of the second radio S 6 during transmit by the first radio T 5 to avoid adjacent channel desensitization (as shown in FIG. 6).

Referring to FIG. 2, a Future Channel Assessment (and Selection) Algorithm 10 is shown. Here, the second radio S 6 (e.g., receiver) of the NC 2 of FIG. 1A is employed to monitor the background noise level of each channel, and preferably maintain a log for one or both of the following parameters: (1) rolling average of RSSI (Receive Signal Strength Indicator); and (2) peak RSSI in or about, for example, the last 24 hours.

### EXAMPLE 3

For example, the RSSI value provides a general indication of the amount of background noise in the corresponding channel. The higher the RSSI value, the stronger the received signal. If the second radio S 6 is receiving background noise, then it is desired that the background noise be relatively low. Conversely, when a packet (message) is received, the first radio T 5 takes an RSSI reading that indicates the strength of the received signal (i.e., a higher RS SI value is better in this instance). After all channels are scanned, as shown in FIG. 2, one technique for selecting the best Future channel (FUTURE_CH) is to simply pick the channel that has the lowest rolling average RSSI (e.g., the channel that has the lowest average background noise). The channel with the second lowest rolling average RSSI (FUTURE_CH′) can also be identified.

### EXAMPLE 4

From the parameters, such as rolling average of RSSI and/or peak RSSI, suitable predetermined threshold values are employed to classify each channel, for example, as excellent, good, fair or poor. For example, when the RSSI value is read, a register is employed to compare and store a Peak_RSSI value. When the compare function is done later to select the lowest ROLLING_AVG_RSSI, the Peak_RSSI value is employed as a secondary qualifier (e.g., if there is more than one channel with the same lowest ROLLING_AVG_RSSI, then pick one of such channels with the lowest Peak_RSSI value).

### EXAMPLE 5

At step 12 of FIG. 2, the channel to be scanned (SCAN_CH) is set to one. Next, at 14, the second radio S 6 is configured to the channel to be scanned (SCAN_CH). Next, at 16, the RSSI value (RSSI_VAL) for that channel is read. At 18, the rolling average RSSI for the scanned channel (ROLLING_AVG_RSSI: SCAN_CH) is calculated and stored. Next, at 20, the channel to be scanned (SCAN_CH) is incremented. At 22, it is determined if the next channel to be scanned (SCAN_CH) is less than or equal to a predetermined count (e.g., without limitation, 16 channels; any suitable count of channels). If so, then step 12 is repeated. Otherwise, at 24, the rolling average RSSIs for all of the scanned channels are compared and the lowest value (e.g., the lowest background noise) is selected to provide the corresponding future channel (FUTURE_CH) and the second lowest value is selected to provide a second future channel (FUTURE_CH′).

### EXAMPLE 6

As alternatives to the rolling average RSSI and peak RSSI parameters, LQI (Link Quality Indicator) with Correlation Value and/or CCA (Clear Channel Assessment) might also be employed as possible parameters. LQI uses the Correlation Value to assess how well an 802.15.4 packet was recognized and received (although the origin/source of the received packets may not be known). LQI and its Correlation Value provide a figure of merit from the radio as to how well the spread spectrum modulation matches (correlates) with what is expected from an 802.15.4 radio.

CCA allows the processor 4 to set a threshold, in order that the second radio S 6 can continuously sample and indicate whenever the RSSI value exceeds that threshold. This makes the RSSI assessment a relatively low overhead task for the processor 4. Here, a suitable threshold is loaded into a register of the second radio S 6. A comparator is employed to determine if the sampled RSSI value is greater than this threshold value. If so, then the radio S 6 generates an interrupt for the processor 4. Hence, CCA indicates when the threshold is exceeded, but does not provide the rolling average RSSI.

As an alternative to background noise level, message traffic may be employed to select the Future channel (FUTURE_CH) (FIGS. 2 and 4). Network loading (percent) is calculated based on the average number of packets sent per second (versus the theoretical maximum possible number of packets sent per second) in order to determine if the channel is too busy to accommodate additional traffic. Another indirect way of measuring this is if the CCA signal indicates that the channel is busy more than about, for example, 30% of the time.

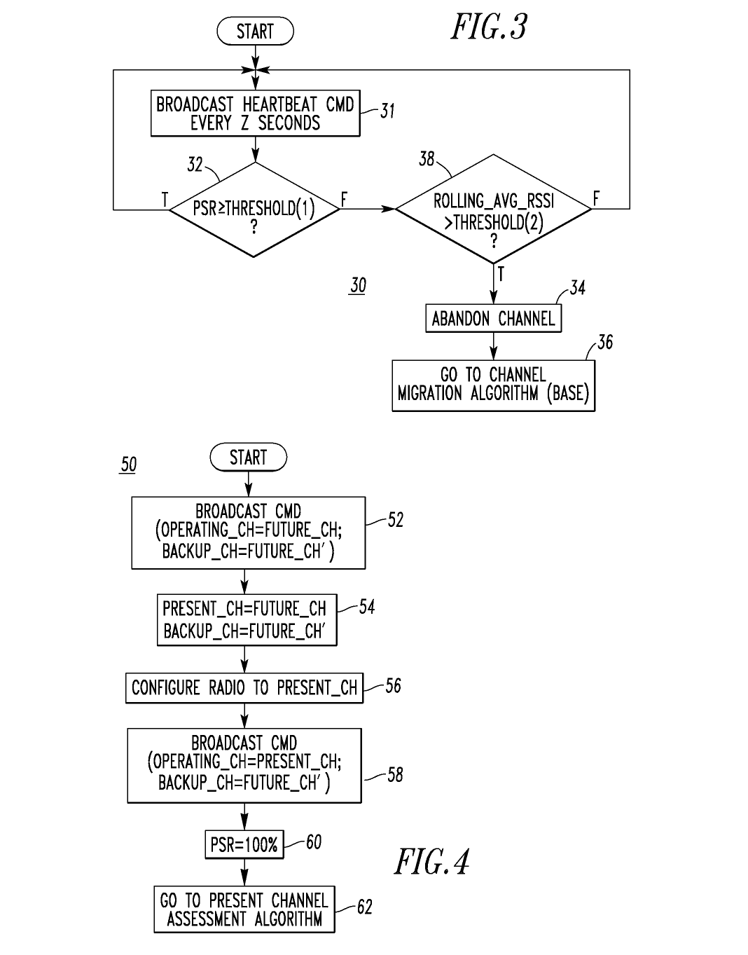

The Future Channel Assessment (and Selection) Algorithm 10 of FIG. 2 looks at other channels to see which other channel might be “useable,” while the Present Channel Assessment (and decision to change) Algorithm 30 of FIG. 3 evaluates the channel currently being used to determine if it is still “good enough” in order to continue to be used. This algorithm 30 also periodically broadcasts a Heartbeat Command at 31 (e.g., at a suitable periodic rate) to indicate to other devices that the present channel should still be used for communications.

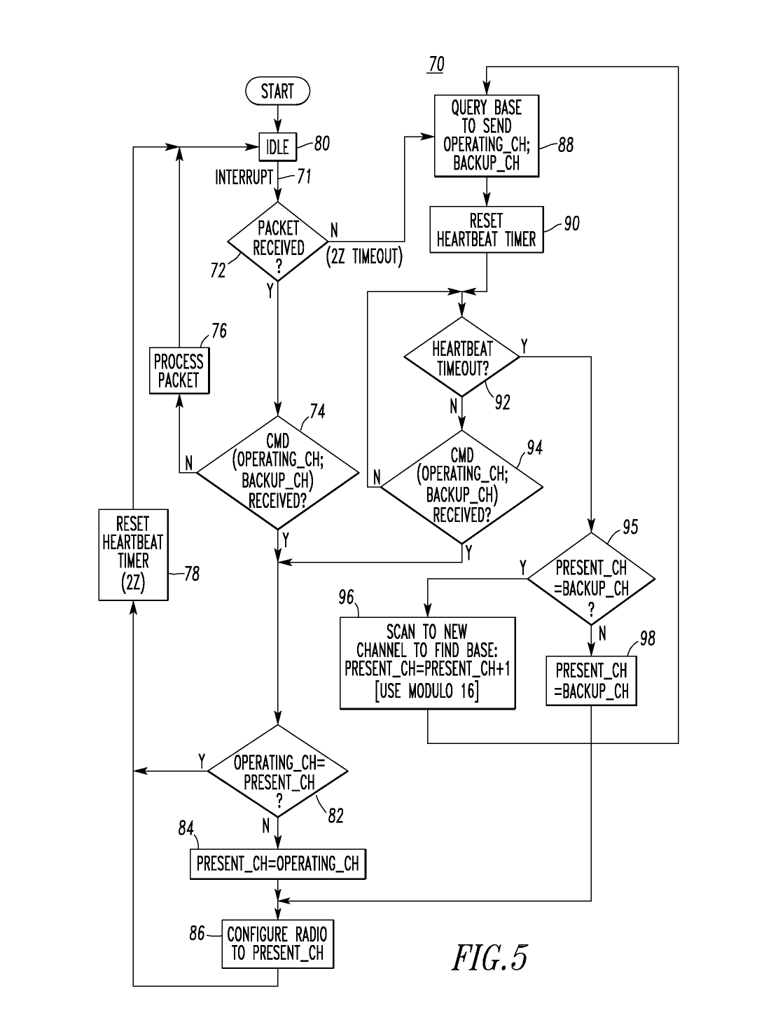

The Heartbeat Command is periodically broadcast at 31 of FIG. 3 by the NC 2 at least about every Z seconds (e.g., without limitation, about every 1 to 15 seconds depending on the application requirements and channel scan rate; any suitable time interval). This allows the NDs 3 to know that as long as they receive the Heartbeat Command, they should remain on the present channel. However, as soon as they stop receiving this Heartbeat Command, they already know the intended future channel for migration. This eliminates the time to scan and find the NC 2, such that the communication network should reform much faster on the new (future) channel. Of course, the scan mechanism of steps 88,90,92,95,96 of FIG. 5 is still needed by any orphaned ND 3 that has not yet found the NC 2.

For example, the first radio T 5 of the NC 2 is used to transmit and receive on the presently selected channel. Several different conditions may be used to assess the quality of the present channel. One of these is PSR (Packet Success Rate), which is the percentage of successful transmissions. Every time a packet is transmitted to a specific destination, the number of retries and un-acknowledged packets are recorded. Then, the application program (not shown) of the processor 4 calculates the PER (Packet Error Rate), which is the percentage of unsuccessful transmissions. At 32, if PSR (=1-PER) is greater than or equal to a first predetermined threshold, then the NC 2 will continue to use the present channel.

However, if the PSR is below the first predetermined threshold, then the processor 4 looks at the rolling average RSSI, at 38. For example, after a packet is received, the processor 4 can request that the first radio T 5 perform an energy detection scan. The first radio T 5 provides back to the processor 4 an RS SI value that indicates the corresponding background noise level of the channel. This value can be used to calculate a rolling average RS SI (ROLLING_AVG_RSSI). Thus, at 38, if the rolling average RS SI exceeds the second predetermined threshold, then this indicates that there is sufficient background noise on the present channel and that it should be abandoned at 34, after which execution resumes, at 36, in the Channel Migration Algorithm (Base) 50 of FIG. 4. On the other hand, if this test is not met, then step 31 is repeated.

### EXAMPLE 7

Under certain circumstances, it may be advantageous to adapt the first and second thresholds of steps 32 and 38 and the dwell (sample time), as follows. If the PSR is below the first predetermined threshold at 32 and if the rolling average RSSI is less than or equal to the second predetermined threshold, then it is possible that the network of the system 1 is sparsely populated and changing channels may or may not improve PSR. Here, the processor 4 can suitably change the first and second predetermined thresholds in order to make a better assessment of whether the present channel is still the best channel for operation.

### EXAMPLE 8

A log of the PSR and the first and second predetermined thresholds for each channel can also be maintained to provide additional information to the Future Channel Assessment (and Selection) Algorithm 10 of FIG. 2 for selecting the best channel. The log (e.g., history) of PSR and the first and second predetermined thresholds, as previously used on other channels, helps to decide why a channel was left previously (e.g., is it worth going back to a former channel again, or should another different channel be chosen this time).

The Channel Migration Algorithm (Base) 50 is shown in FIG. 4. After the NC 2 decides to change channels, at steps 34 and 36 of FIG. 3, it takes the result (FUTURE_CCH FUTURE_CCH′) of the Future Channel Assessment (and Selection) Algorithm 10 of FIG. 2 and broadcasts that result, employing its first radio T 5 at 52 of FIG. 4, to the network of the system 1 to indicate that it is changing the operating channel to the future channel (FUTURE_CH), and the backup channel to FUTURE_CH′. Next, at 54, the NC 2 sets the present channel (PRESENT_CH) to the future channel (FUTURE_CH) and the BACKUP_CH to FUTURE_CH′ and, at 56, configures its first radio T 5 to use the new present channel (PRESENT_CH=FUTURE_CH). At 58, the NC 2 broadcasts the command (CMD) to set the operating channel (OPERATING_CH) to the new present channel and the BACKUP_CH to FUTURE_CH′ and continues to operate from there. Then, at 60, the NC 2 sets PSR to 100% after which execution resumes, at 62, in the Present Channel Assessment Algorithm 30 of FIG. 3.

FIG. 5 shows the Channel Migration Algorithm (Device) 70. When a network device, such as ND 3, receives the broadcast command of step 58 of FIG. 4 to change to a new channel, it changes channels and continues to operate from there. If such a network device does not see any network traffic (or heartbeat) on the present channel from the NC 2 for 2*Z seconds, then it will query the NC 2 to see if it is still there. Otherwise, the ND 3 will either change to the backup channel or begin scanning channels to find the new operating channel of the NC 2.

At 72 of FIG. 5, in response to a receive interrupt 71, the ND 3 determines if a packet was received on its radio T 5. If so, then at 74, it determines whether an operating channel command (step 58 of FIG. 4) was received. If not, then, the received packet is processed at 76, before returning to an idle state at 80. Otherwise, if the operating channel command was received, as determined at 74, then it is determined at 82 if the operating channel of that command is the present channel. If so, then execution resumes at 78. Otherwise, the present channel (PRESENT_CH) is set to the new operating channel (OPERATING_CH) at 84. Next, at 86, the radio T 8 of the ND 3 is configured to the present channel, after which execution resumes at 78.

On the other hand, if no packet was received at 72 after the timeout period (e.g., 2*Z seconds) has expired, then at 88, the ND 3 queries the NC 2 to send the correct operating channel and backup channel. Next, at 90, the heartbeat timer is reset. Then, at 92, it is determined if there is a timeout of the heartbeat timer. If not, then at 94, it is determined whether the operating channel command (step 58 of FIG. 4) was received. If not, then execution resumes at 92. Otherwise, if the operating channel command was received, then execution resumes at 82. On the other hand, at 92, if there was timeout of the heartbeat timer, then at 95, it is determined if the present channel (PRESENT_CH) is equal to the backup channel (BACKUP_CH). If so, then at 96, the ND 3 scans the various channels to find the NC 2 by incrementing the present channel (PRESENT_CH) (e.g., without limitation, modulo 16), before resuming execution at 88. Otherwise, if the present channel is different than the backup channel at 95, then at 98, the present channel is set equal to the backup channel after which step 86 is executed. There, the channel is changed to try and locate the NC.

FIG. 6 shows a transmit routine 110 employed by the NC 2 of FIG. 1B, in order to disable the receiver of the second radio S 6 during transmit by the first radio T 5. This avoids adjacent channel desensitization resulting from crosstalk. At 112, the first radio T 5 of FIG. 1A or 1B is in a receive mode or an idle mode. Next, at 114, prior to a possible transmission, the receiver of the second radio S 6 of FIG. 1A or 1B is enabled (and does a channel assessment) (FIG. 2). Next, at 116, it is determined whether there is anything to transmit. If not, then step 116 is repeated. Otherwise, responsive to a transmit interrupt 117, at 118, the receiver of the second radio S 6 of FIG. 1A or 1B is disabled, after which the transmission from the first radio T 5 is undertaken at 120, after which step 112 is repeated.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A wireless communication network comprising:
a network coordinator comprising a processor, a first wireless radio employed to transmit and receive on a presently selected channel, and a second wireless radio; and
a number of network devices, each of said network devices comprising a processor and a wireless radio,
wherein said network coordinator and said number of network devices are structured to wirelessly communicate by employing a first wireless communication channel as said presently selected channel,
wherein said network coordinator is structured to monitor a number of different second wireless communication channels with the second wireless radio of said network coordinator,
wherein said network coordinator is structured to select one of said different second wireless communication channels as a function of background noise level or message traffic,
wherein said network coordinator is structured to monitor the first wireless communication channel with the first wireless radio of said network coordinator,
wherein said network coordinator is structured to determine that the first wireless communication channel has unsatisfactory quality and responsively broadcast an identification of the selected one of said different second wireless communication channels to said number of network devices, and
wherein said network coordinator and the number of network devices are structured to wirelessly communicate between the network coordinator and the number of network devices by employing the selected one of said different second wireless communication channels as said presently selected channel.

2. The wireless communication network of claim 1 wherein said network coordinator further comprises a single antenna and a duplexer; and wherein the second wireless radio of said network coordinator is in a receive only mode and uses the same single antenna as said first wireless radio through said duplexer.

3. The wireless communication network of claim 1 wherein the first wireless radio of said network coordinator includes a transmitter; wherein the first and second wireless radios of said network coordinator both include a receiver;
and wherein the receivers of said first and second wireless radios are both disabled during transmission by the transmitter of said first wireless radio.

4. A method of dynamic channel selection for a wireless communication network, said method comprising:
wirelessly communicating between a network coordinator and a number of network devices by employing a first wireless communication channel of a first wireless radio of each of said network coordinator and said number of network devices;
employing a second wireless radio of said network coordinator;
monitoring a number of different second wireless communication channels with the second wireless radio of said network coordinator;
selecting one of said different second wireless communication channels as a function of background noise level or message traffic;
monitoring the first wireless communication channel with the first wireless radio of said network coordinator;
determining that the first wireless communication channel has unsatisfactory quality and responsively broadcasting an identification of the selected one of said different second wireless communication channels to said number of network devices; and
wirelessly communicating between the network coordinator and the number of network devices by employing the selected one of said different second wireless communication channels.

5. The method of claim 4 further comprising
employing the first wireless radio of said network coordinator to responsively broadcast the identification of the selected one of said different second wireless communication channels to said number of network devices and to wirelessly communicate between the network coordinator and the number of network devices by employing the selected one of said different second wireless communication channels.

6. The method of claim 4 further comprising
determining that the first wireless communication channel has unsatisfactory quality by determining that the percentage of successful transmissions from said network coordinator to said number of network devices is less than a predetermined amount.

7. The method of claim 4 further comprising
employing as said function of background noise level or message traffic a function of lowest average background noise level.

8. The method of claim 4 further comprising
employing as said function of background noise level or message traffic the selection of one of said different second wireless communication channels that has the lowest rolling average receive signal strength indicator value.

9. The method of claim 8 further comprising
determining whether more than one of said different second wireless communication channels has the lowest rolling average receive signal strength indicator value; and
selecting said one of said different second wireless communication channels having the lowest peak receive signal strength indicator value over a predetermined time period.

10. The method of claim 9 further comprising
employing about one day as said predetermined time period.

11. The method of claim 9 further comprising
maintaining a log for at least one of said lowest rolling average receive signal strength indicator value and said lowest peak receive signal strength indicator value for each of said different second wireless communication channels.

12. The method of claim 4 further comprising
abandoning the first wireless communication channel after said determining that the first wireless communication channel has unsatisfactory quality and before said responsively broadcasting an identification of the selected one of said different second wireless communication channels to said number of network devices.

13. The method of claim 4 further comprising
determining that the first wireless communication channel has unsatisfactory quality by determining that the percentage of successful transmissions from said network coordinator to said number of network devices is less than a first predetermined amount, and by determining that a rolling average receive signal strength indicator value of said first wireless communication channel is greater than a second predetermined amount.

14. The method of claim 13 further comprising
abandoning the first wireless communication channel after said determining that the first wireless communication channel has unsatisfactory quality and before said responsively broadcasting an identification of the selected one of said different second wireless communication channels to said number of network devices.

15. The method of claim 4 further comprising
configuring the first wireless radio of said network coordinator with the selected one of said different second wireless communication channels before said responsively broadcasting an identification of the selected one of said different second wireless communication channels to said number of network devices.

16. The method of claim 4 further comprising
receiving the responsively broadcasted identification of the selected one of said different second wireless communication channels at one of said network devices; and
responsively changing the first wireless radio of said one of said network devices to use the selected one of said different second wireless communication channels.

17. The method of claim 16 further comprising
determining at said one of said network devices that there is no network traffic on the selected one of said different second wireless communication channels and responsively querying the network coordinator to send an identification of said selected one of said different second wireless communication channels.

18. The method of claim 4 further comprising
determining at one of said network devices that there is no network traffic on the selected one of said different second wireless communication channels after a predetermined time and responsively scanning said different second wireless communication channels to find the selected one of said different second wireless communication channels of said network coordinator.

19. The method of claim 4 further comprising
employing a receiver of the second wireless radio of said network coordinator; and
disabling said receiver of the second wireless radio during transmission by the first wireless radio of said network coordinator.

20. The method of claim 4 further comprising
selecting another one of said different second wireless communication channels as a function of background noise level or message traffic; and
broadcasting an identification of said another one of said different second wireless communication channels along with the selected one of said different second wireless communication channels to said number of network devices.
